(19) United States
(12) Patent Application Publication
(10) Pub. No.: US 2026/0030941 A1
(43) Pub. Date: Jan. 29, 2026

(54) DOOR LOCK SECURITY ASSESSMENT METHOD AND RELATED DEVICE

(71) Applicant: SHENZHEN TCL NEW TECHNOLOGY CO., LTD., Shenzhen, Guangdong (CN)

(72) Inventors: Kang LUO, Shenzhen, Guangdong (CN); Mingde LI, Shenzhen, Guangdong (CN)

(73) Assignee: SHENZHEN TCL NEW TECHNOLOGY CO., LTD., Shenzhen, Guangdong (CN)

(21) Appl. No.: 18/998,499

(22) PCT Filed: Jun. 9, 2023
(86) PCT No.: PCT/CN2023/099363

§ 371 Date: Jan. 26, 2025

(30) Foreign Application Priority Data
Jul. 27, 2022 (CN) 202210894160.X

(51) Int. Cl. G07C 9/00

(52) U.S. Cl. CPC G07C 9/00309; G07C 2009/00634

(57) ABSTRACT

A door lock security assessment method and a related device. The method comprise: sending a security assessment instruction to a door lock end, so as to trigger the door lock end to perform local security environment assessment to obtain a first security index corresponding to the door lock end; acquiring historical behavior data for the door lock end within a specified time period; performing security assessment analysis on the historical behavior data to obtain a second security index; receiving a third security index, which is sent by a control end; determining a security assessment result of a door lock on the basis of the first security index, the second security index and the third security index; and sending the security assessment result of the door lock to the control end.

This application claims the priority of Chinese Patent Application No. 202210894160.X, entitled “DOOR LOCK SECURITY ASSESSMENT METHOD AND RELATED DEVICE”, filed on Jul. 27, 2022, the disclosure of which is incorporated herein by reference in its entirety.

### FIELD OF THE DISCLOSURE

The present disclosure relates to intelligent electronic device, and more particularly, to a door lock security assessment method and related device.

### BACKGROUND

As smart door locks become more and more popular, their security is increasingly challenged, and consumers are more and more concerned about the security of smart door locks.

In the conventional related technology, generally only the door lock end is analyzed for security assessment to obtain the security assessment result. Then, the user performs security settings for the door lock according to the security assessment result. This assessment method is relatively simple, and the accuracy of the security assessment results is relatively low.

### SUMMARY

One objective of an embodiment of the present disclosure is to provide a door lock security assessment method and related device, where the device may include a door lock security evaluation device, an electronic device, a computer-readable storage medium and a computer program product, and the accuracy of the corresponding security assessment result of the door lock can be improved.

According to an embodiment of the present disclosure, a door lock security assessment method is disclosed. The method comprises:
sending a security evaluation instruction to a door lock end to trigger the door lock end to perform a local security environment assessment and obtain a first safety index corresponding to the door lock end;
obtaining historical behavior data for the door lock end within a specified time period;
performing a security evaluation analysis on the historical behavior data to obtain a second safety index;
receiving a third security index sent by a control end and the first security index sent by the door lock end, wherein the third security index is obtained by the control end performing the local security environment assessment;
determining a security assessment result of a door lock based on the first security index, the second security index and the third security index; and sending the security assessment result of the door lock to the control end.

According to another embodiment of the present disclosure, a door lock security assessment method is disclosed. The method comprises:
performing a security assessment on a local environment to obtain the third safety index when the security assessment instruction is received;
sending the third security index to a server to trigger the server to obtain a first security index and a second security index, wherein the first security index is obtained by a door lock end performing a security assessment on a corresponding local environment, and the second security index is obtained by the server performing a security assessment on historical behavior data of the door lock end in a specified time period;
receiving a security assessment result sent by the server, wherein the security assessment result is calculated by the server based on the first security index, the second security index and the third security index.

According to another embodiment of the present disclosure, a door lock security assessment method is disclosed. The method comprises:
receiving the security evaluation instruction sent by a server, wherein the security evaluation instruction is issued after the server receives the third security index, and the third security index is obtained by the control end performing a local security environment assessment;
performing a security assessment on a local environment according to the security assessment instruction to obtain a first safety index;
sending the first security index to the server to trigger the server to calculate a security assessment result of the door lock based on the first security index, a second security index and the third security index, wherein the second security index is obtained by the server performing a security assessment on historical behavior data of a door lock end within a specified period of time.

Correspondingly, according to another embodiment of the present disclosure, a door lock security assessment includes:
a first transmitting unit, configured for sending a security evaluation instruction to a door lock end to trigger the door lock end to perform a local security environment assessment and obtain a first safety index corresponding to the door lock end;
an obtaining unit, configured for obtaining historical behavior data for the door lock end within a specified time period;
a first evaluation unit, configured for performing a security evaluation analysis on the historical behavior data to obtain a second safety index;
a first receiving unit, configured for receiving a third security index sent by a control end and the first security index sent by the door lock end, wherein the third security index is obtained by the control end performing the local security environment assessment;
a determining unit, configured for determining a security assessment result of a door lock based on the first security index, the second security index and the third security index; and
a second transmitting unit, configured for sending the security assessment result of the door lock to the control end.

According to another embodiment of the present disclosure, a door lock security assessment includes:
a second evaluation unit, configured for performing a security assessment on a local environment to obtain a third safety index when the security assessment instruction is received;
a third transmitting unit, configured for sending the third security index to a server to trigger the server to obtain a first security index and a second security index, wherein the first security index is obtained by a door lock end performing a security assessment on a corresponding local environment, and the second security index is obtained by the server performing a security assessment on historical behavior data of the door lock end in a specified time period; and
a second receiving unit, configured for receiving a security assessment result sent by the server, wherein the security assessment result is calculated by the server based on the first security index, the second security index and the third security index.

According to another embodiment of the present disclosure, a door lock security assessment includes:
a third receiving unit, configured for receiving the security evaluation instruction sent by a server, wherein the security evaluation instruction is issued after the server receives the third security index, and the third security index is obtained by the control end performing a local security environment assessment;
a third evaluation unit, configured for performing a security assessment on a local environment according to the security assessment instruction to obtain a first safety index; and
a fourth transmitting unit, configured for sending the first security index to the server to trigger the server to calculate a security assessment result of the door lock based on the first security index, a second security index and the third security index, wherein the second security index is obtained by the server performing a security assessment on historical behavior data of a door lock end within a specified period of time.

Optionally, in some embodiments of the present disclosure, the historical behavior data comprises at least one historical interaction information.

The first evaluation unit may comprise an analysis subunit and a first determination subunit.

The analysis subunit is used for performing an abnormality analysis of at least one dimension on the historical behavior data based on an interaction time corresponding to each historical interaction information to obtain an abnormal result in at least one dimension; and

The first determination subunit is used to determine the second safety index according to the formula:

$$P 2 = 100 - 100 * {\sum }_{i = 1}^{n} {D}_{i} {R}_{i} ,$$

where P2 represents the second safety index, Ri represents the corresponding risk coefficient of each dimension, Di represents the abnormal results in each dimension, and n represents the number of dimensions.

Optionally, in some embodiments of the present disclosure, the analysis subunit may be specifically used to detect whether there is historical interaction information in the historical behavior data that the interaction time belongs to the preset abnormal time, so as to obtain a first abnormal result; Or, based on the interaction time corresponding to each historical interaction information, the abnormal frequency of the historical behavior data is analyzed to obtain a second abnormal result.

Optionally, in some embodiments of the present disclosure, the determining unit may include a computational subunit and a second determination subunit.

The calculation subunit is used for calculating a corresponding security assessment score of the door lock based on the formula P=(P1+P2+P3)/3, where P represents the security assessment score, P1 represents the first security index, P2 represents the second security index, and P3 represents the first security index.

The second determining subunit is used for determining the security assessment result of the door lock according to the security assessment score.

Optionally, in some embodiments of the present disclosure, the second determination subunit may be specifically used to generate a first security assessment result for the door lock when the security assessment score is greater than a preset value, and generate a second security assessment result for the door lock when the security assessment score is not greater than the preset value.

Optionally, in some embodiments of the present disclosure, the second evaluation unit may comprise a third determination subunit, a first detection subunit and a fourth determination subunit.

The third determination subunit is used for determining a risk factor corresponding to security attribute information in the dimension of the local environment when the security assessment instruction is received.

The first detection subunit is used for detecting whether a attribute value corresponding to the security attribute information in the dimension satisfies a preset security condition.

The fourth subunit is used for obtaining the third security index based on a detection result and the risk factor of the security attribute information in each dimension.

Optionally, in some embodiments of the present disclosure, the third evaluation unit may comprise a fifth determination subunit, a second detection subunit and a sixth determination subunit.

The fifth determination subunit is used for determining the risk factor corresponding to the security attribute information on each dimension of the local environment according to the security assessment instruction.

The second detection subunit is used for detecting whether the attribute value corresponding to the security attribute information on the dimension satisfies the preset safety condition.

The sixth subunit is determined to obtain the first safety index based on the detection results and risk coefficients of the security attribute information in each dimension.

According to another embodiment of the present disclosure, an electronic device includes a processor and a memory storing an application executed by the processor to perform the steps of the door lock security assessment method as stated above.

According to another embodiment of the present disclosure, a non-transitory computer-readable storage medium stores a plurality of computer-readable instructions executable by a processor to perform the steps of the door lock security assessment method as stated above.

According to another embodiment of the present disclosure, a computer program product includes computer program or computer-readable instruction executed by a processor to perform the steps of the door lock security assessment method as stated above.

### BRIEF DESCRIPTION OF THE DRAWINGS

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be acquired according to these drawings without creative labor.

FIG. 1a is a diagram of a scene for a door lock security assessment method according to an embodiment of the present disclosure.

FIG. 1b is a flow chart of the door lock security assessment method according to an embodiment of the present disclosure.

FIG. 1c is a flow chart of the door lock security assessment method according to another embodiment of the present disclosure.

FIG. 2a is a flow chart of the door lock security assessment method according to another embodiment of the present disclosure.

FIG. 2b is a flow chart of the door lock security assessment method according to another embodiment of the present disclosure.

FIG. 3a is a flow chart of the door lock security assessment method according to another embodiment of the present disclosure.

FIG. 3b is a flow chart of the door lock security assessment method according to another embodiment of the present disclosure.

FIG. 4a is a block diagram of a door lock security evaluation device according to an embodiment of the present disclosure.

FIG. 4b is a block diagram of the door lock security evaluation device according to another embodiment of the present disclosure.

FIG. 4c is a block diagram of the door lock security evaluation device according to another embodiment of the present disclosure.

FIG. 5 illustrates a schematic diagram of the electronic device according to another embodiment of the present disclosure.

### DETAILED DESCRIPTION OF THE PRESENT DISCLOSURE

The technical solution in the embodiment of the present disclosure will be clearly and completely described below in conjunction with the accompanying drawings in the embodiment of the present disclosure. Obviously, the described embodiments are only some embodiments of the present disclosure, not all embodiments. Based on the embodiments in the present disclosure, all other embodiments obtained by a person skilled in the art without creative work fall within the scope of protection of the present disclosure.

The embodiment of the application provides a door lock security evaluation method and related device, and the related device may include a door lock security evaluation device, an electronic device, a computer-readable storage medium and a computer program product. The door lock security evaluation device can be integrated into an electronic device, which can be a terminal or a server.

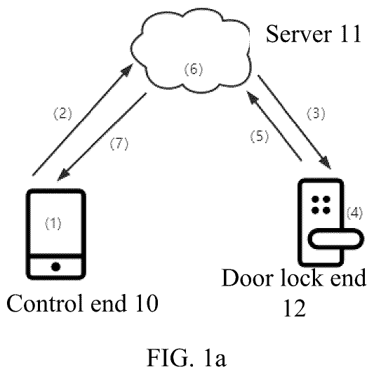

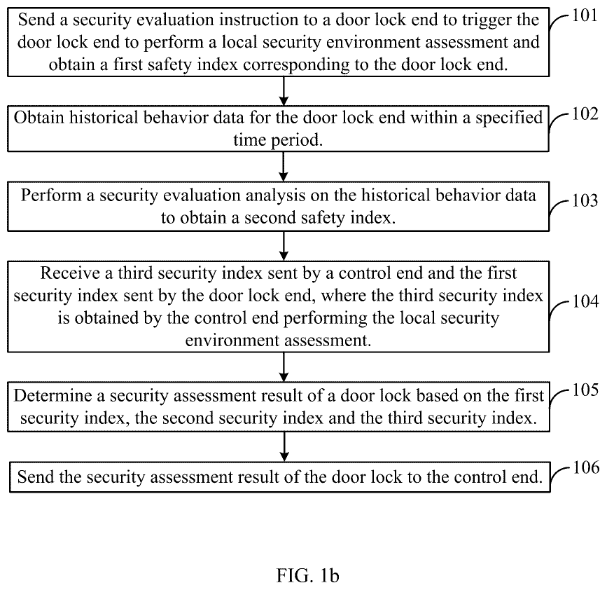

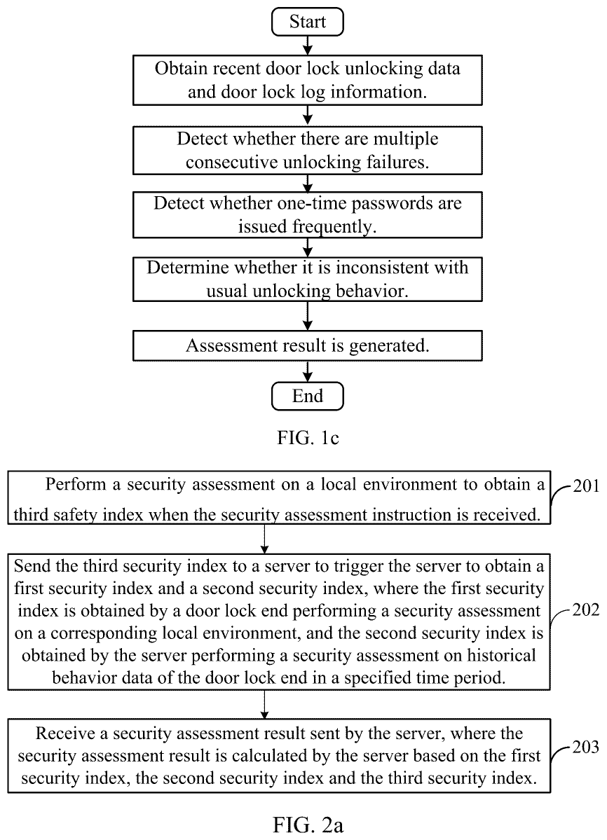

As shown in FIG. 1a, the door lock security evaluation system of an embodiment of the present disclosure may comprise a control terminal 10 (i.e., the control end of the door lock), a server 11 and a door lock end 12. The control terminal 10 is connected with the server 11 through a network, and the door lock end 12 is also connected with the server 11 through a network, such as a wired or wireless network connection. Here, the door lock security evaluation device can be integrated in the server.

The control terminal 10 can be used for: performing a security assessment on a local environment to obtain a third safety index when the security assessment instruction is received; sending the third security index to a server 11 to trigger the server 11 to obtain a first security index and a second security index, wherein the first security index is obtained by a door lock end 12 performing a security assessment on a corresponding local environment, and the second security index is obtained by the server 11 performing a security assessment on historical behavior data of the door lock end 12 in a specified time period; and receiving a security assessment result sent by the server 11, wherein the security assessment result is calculated by the server 11 based on the first security index, the second security index and the third security index. Here, the control terminal 10 can include a mobile phone, a tablet, an electronic watch, an electronic bracelet and the like. Furthermore, the control terminal 10 can also be provided with a client end, which can be an application client and so on.

The door lock end 12 can be used for: receiving the security evaluation instruction sent by the server 11, wherein the security evaluation instruction is issued after the server 11 receives the third security index, and the third security index is obtained by the control terminal 10 performing the local security environment assessment; performing a security assessment on the local environment according to the security assessment instruction to obtaining a first safety index; sending the first security index to the server 11 to trigger the server 11 to calculate the security assessment result of the door lock based on the first security index, the second security index and the third security index, wherein the second security index is obtained by the server 11 performing a security assessment on the historical behavior data of the door lock end 12 within a specified time period.

The server 11 may be used for: sending the security evaluation instruction to the door lock end 12 to trigger the door lock end 12 to perform local security environment assessment to obtaining the first security index corresponding to the door lock end 12; obtaining the historical behavior data for the door lock end 12 within the specified time period; performing a security evaluation analysis on the historical behavior data to obtain a second safety index; receiving the third security index sent by the control terminal 10, wherein the third security index is obtained by the control terminal 10 performing the local security environment evaluation; receiving the first security index sent by the door lock end; determining the security assessment result of the door lock based on the first security index, the second security index and the third security index; and sending the security assessment result of the door lock to the control terminal 10. Here, the server 11 can be a single server, a server cluster composed of multiple servers, or a cloud server.

The above door lock security evaluation steps performed by the server 11 may also be performed by the control terminal 10.

In the following disclosure, the order of illustrating following embodiments is not a limitation for determining a preferred embodiment of the present disclosure.

The embodiment will be described from the perspective of a first door lock security evaluation device. The first door lock security evaluation device can be integrated in a first electronic device, and the electronic device can be a server.

As shown in FIG. 1b, the flow of the door lock security evaluation method can be as follows:
101: sending a security evaluation instruction to a door lock end to trigger the door lock end to perform a local security environment assessment and obtain a first safety index corresponding to the door lock end.
102: obtaining historical behavior data for the door lock end within a specified time period.
103: performing a security evaluation analysis on the historical behavior data to obtain a second safety index.
104: receiving a third security index sent by a control end and the first security index sent by the door lock end, wherein the third security index is obtained by the control end performing the local security environment assessment.
105: determining a security assessment result of a door lock based on the first security index, the second security index and the third security index.
106: sending the security assessment result of the door lock to the control end.

The above-mentioned control end is the control end of the door lock. The control end of the door lock can be an electronic device that can control unlocking, The control end can be a mobile phone, which is not a limitation of the present disclosure. This embodiment can utilize the security of the control end to determine the security of the door lock.

Optionally, the historical behavior data includes at least one historical interaction information;

The step of performing the security evaluation analysis on the historical behavior data to obtain the second safety index may comprise: performing an abnormality analysis of at least one dimension on the historical behavior data based on an interaction time corresponding to each historical interaction information to obtain an abnormal result in at least one dimension; and determining the second safety index according to the formula:

$$P 2 = 100 - 100 \times {\sum }_{i = 1}^{n} DiRi ,$$

where P2 represents the second safety index, Ri represents a corresponding risk factor of each dimension, Di represents the abnormal result in each dimension, and n represents a number of dimensions.

The specified time period corresponding to the historical behavior data can be set according to the actual situation, such as three months or half a year. The historical behavior data can be the unlocking data of the door lock, such as the unlocking time information and whether the unlocking was successful.

In this embodiment, the security of the door lock can be improved by analyzing the recent door lock unlocking data.

The unlocking data of each unlock of the door lock can be regarded as an interactive message.

The step of performing an abnormality analysis of at least one dimension on the historical behavior data can be to analyze whether there were multiple frequent unlocking failures recently, and whether there are frequent download of one-time passwords. These analyses all falls within the scope of the present disclosure and are not limitations.

Specifically, the second safety index can be determined according to the risk factor corresponding to the abnormality analysis in each dimension and the abnormal result. For example, the risk factor is used as a weight to weight the abnormal result in each dimension to obtain the second safety index. For the abnormal result in each dimension, the abnormality result can be set to 0 when there is an abnormality, and the abnormality result can be set to 1 when there is no abnormality.

Optionally, the step of performing the abnormality analysis of at least one dimension on the historical behavior data based on the interaction time corresponding to each historical interaction information to obtain the abnormal result in at least one dimension may include: detecting whether there is historical interaction information where the interaction time belongs to a preset abnormal time in the historical behavior data to obtain the first abnormal result; or analyzing an abnormal frequency of the historical behavior data based on the interaction time corresponding to each historical interaction information to obtain a second abnormal result.

The preset abnormal time can be set according to the actual situation and is not limited in this embodiment. Specifically, the preset abnormal time can also be determined according to the interaction time corresponding to each historical interaction information, such as the time period that the interaction time is not distributed can be taken as the preset abnormal time.

When there is historical interaction information in the historical behavior data that the interaction time belongs to the preset abnormal time, the first abnormal result can be set to 0.

Based on the interaction time corresponding to each historical interaction information, the abnormal frequency of historical behavior data is analyzed. Specifically, it can analyze whether there were multiple frequent unlocking failures recently or whether there are frequent downloads of one-time passwords. When the abnormal frequency exceeds the preset value, the second abnormal result can be set to 0.

In this embodiment, the user unlocking behavior information can be stored in the cloud, and the recent door lock unlocking data can be obtained through the cloud and analyzed, such as analyzing whether there were multiple frequent unlocking failures recently or whether there were frequent downloads of one-time passwords. According to the analysis results, the second security index P2 is calculated.

In a specific embodiment, please refer to FIG. 1c, a flow chart of cloud platform security assessment method is shown. The method comprises:
1. obtaining recent (half a year or three months) door lock unlocking data and door lock log information, and generating a trend chart, an abnormal unlocking node and related information.
2. When there were multiple frequent unlocking failures recently, the abnormal result in this dimension indicates that the security detection fails.
3. When there were frequent downloads of one-time password recently, the abnormal result in this dimension indicates that the security detection fails.
4. When the recent unlocking behavior is abnormal and does not conform to the usual unlocking behavior, for example, it does not meet the user's usual unlocking time, the abnormal result in this dimension indicates that the security detection fails.
5. Based on the abnormal result in each dimension, the assessment score is calculated and the assessment result is generated accordingly. Here, the assessment result is the second safety index.

Optionally, in this embodiment, the step of determining the security assessment result of the door lock based on the first security index, the second security index and the third security index may comprise: calculating a corresponding security assessment score of the door lock based on the formula P=(P1+P2+P3)/3, wherein P represents the security assessment score, P1 represents the first security index, P2 represents the second security index, and P3 represents the first security index; and determining the security assessment result of the door lock according to the security assessment score.

In some embodiments, different security assessment scores can correspond to different security levels. For example, when the security assessment score is above 80 points, the security assessment result can be safe. When the security assessment score is 60-80 points, the security assessment result can be a certain risk. When the security assessment score is less than 60 points, the security assessment result can be a greater risk.

In a specific embodiment, the first security index of the smart door lock end is recorded as P1, the second security index corresponding to the cloud platform is recorded as P2, and the third security index corresponding to the mobile phone control end is recorded as P3, and the comprehensive security assessment score P=(P1+P2+P3)/3.

Specifically, please refer to FIG. 1a. FIG. 1a is a diagram of a scene for a door lock security assessment method according to an embodiment of the present disclosure. The related scene is illustrated as follows:
1. The user activates the application program corresponding to the door lock on the mobile phone and clicks the application program to perform the smart lock security environment evaluation. The security environment assessment on the mobile phone can be performed first.
2. The security assessment result of the mobile phone is sent to the cloud platform.
3. The cloud platform issues a security assessment instruction to the smart door lock.
4. Performing a security environment assessment on the smart door lock end.
5. The security assessment result of the smart door lock end is sent to the cloud platform.
6. The user unlocking behavior stored in the cloud platform is analyzed, and then the overall security assessment result of the door lock is obtained based on the security assessment results of the cloud platform, the mobile phone and the smart door lock.
7. The final assessment result and the security recommendation are transmitted to the user's mobile phone.

The present disclosure can make the user have a clear understanding of the security of the smart door lock through the multi-dimensional security assessment of the mobile phone control end, the smart door lock end and the cloud platform end corresponding to the smart door lock. Based on the security assessment results, some unsafe settings and behaviors of the user can be prompted, so as to ensure the safety of the user and the property and improve the security of the smart door lock.

Optionally, in this embodiment, the step of determining the security assessment result of the door lock according to the security assessment score may comprise: when the security assessment score is greater than a preset value, generating a first security assessment result for the door lock; and when the security assessment score is not greater than the preset value, generating a second security assessment result for the door lock.

The default value can be set according to the actual situation and is not limited in this embodiment. Specifically, when the security assessment score is greater than the preset value, the first security assessment result can be determined to be safe. When the security assessment score is not greater than the preset value, the second security assessment result can be determined as risky.

It can be seen from the above that this embodiment can send a security evaluation instruction to the door lock end to trigger the door lock end to perform a local security environment assessment and obtain the first safety index corresponding to the door lock end; obtain historical behavior data for the door lock end within a specified time period; perform a security evaluation analysis on the historical behavior data to obtain the second safety index; receive the third security index sent by the control end and the first security index sent by the door lock end, where the third security index is obtained by the control end performing the local security environment; determine the security assessment result of the door lock based on the first security index, the second security index and the third security index; send the security assessment result of the door lock to the control end. The present disclosure can evaluate the security of the door lock by combining three aspects, the door lock end, the control end and the historical behavior data, and the accuracy of the corresponding security assessment result of the door lock is improved.

In a following embodiment, it will be illustrated from the perspective of a second door lock security evaluation device. The second door lock security evaluation device can be integrated into a second electronic device. The second electronic device may be a terminal or other device.

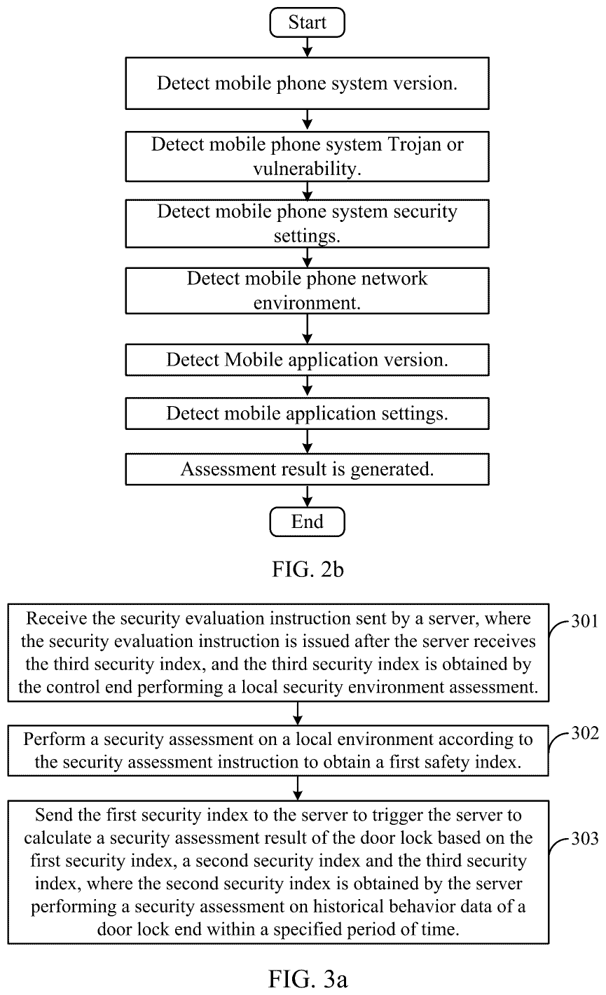

As shown in FIG. 2a, the process flow of the door lock security evaluation method is as follows:
201: performing a security assessment on a local environment to obtain a third safety index when the security assessment instruction is received.
202: sending the third security index to a server to trigger the server to obtain a first security index and a second security index, wherein the first security index is obtained by a door lock end performing a security assessment on a corresponding local environment, and the second security index is obtained by the server performing a security assessment on historical behavior data of the door lock end in a specified time period.
203: receiving a security assessment result sent by the server, wherein the security assessment result is calculated by the server based on the first security index, the second security index and the third security index.

Optionally, in this embodiment, the step of performing the security assessment on the local environment to obtain the third safety index when the security assessment instruction is received may comprise: when the security assessment instruction is received, determining a risk factor corresponding to security attribute information in the dimension of the local environment; detecting whether a attribute value corresponding to the security attribute information in the dimension satisfies a preset security condition; and obtaining the third security index based on a detection result and the risk factor of the security attribute information in each dimension.

Here, the local environment can be the environment corresponding to the control end of the door lock. The control end of the door lock can be an electronic device that can control unlocking, such as a mobile phone, which is not a limitation of the present disclosure. This embodiment may use the security of the control end to determine the security of the door lock.

The security attribute information in each dimension can include the system version, Trojan and/or loopholes of the control end, and the application version about unlocking application programs, networking environment, etc.

The risk factor corresponding to the security attribute information in each dimension can be the risk factor when the attribute value of the security attribute information in each dimension does not pass the preset security condition. Or it can be understood as the importance of the security attribute information in each dimension.

The detection result of the security attribute information in each dimension can be recorded as D. When the attribute value corresponding to the security attribute information in the dimension meets the preset security condition, the security attribute information in the dimension can be regarded as passing the security test, and the detection result D is set to 1. When the attribute value of the security attribute on the dimension does not meet the preset security condition, the security attribute on the dimension can be regarded as failing the security test, and the detection result D is set to 0.

The preset safety condition can be set according to the actual situation and is not a limitation in this embodiment. For example, when the security attribute information in a certain dimension is the system version of the mobile phone, and the attribute value can be the version number, the preset security condition can be that the mobile phone system version is not lower than the latest released version. In another example, when the security attribute information in a dimension is a system Trojan or a loophole, the attribute value can be whether the system has a Trojan or a loophole, and the preset security condition can be that the system does not have a Trojan horse or vulnerability.

The step of obtaining the third security index based on detection results and risk factors of the security attribute information in each dimension may comprise: taking the risk factor of the security attribute information in each dimension a weight; and based on the weight, performing a weighted operation on the detection result of the security attribute information in each dimension to obtain the third security index corresponding to the control end.

It is understandable that the third safety index can be obtained by other means, which is not a limitation of the present disclosure.

In a specific scenario, the corresponding control end of the door lock can be a mobile phone terminal. For the mobile phone terminal, the number of security assessment detection items number n can be first determined. That is, the number n is the number of dimensions of the security attribute information. For example, the security assessment detection items (the security attribute information in each dimension) can include: the mobile phone system version, Trojan or loophole detection, the application version, the mobile phone networking environment, etc. Here, the detection result of each security assessment test item is recorded as Di, the risk factor is recorded as Ri, and the third security index is recorded as P3. Then the corresponding third security index of the mobile phone can be:

$$P 3 = 100 - 100 \times {\sum }_{i = 1}^{n} DiRi .$$

The sum of the risk factors of each security assessment test item can be 1.

FIG. 2b shows the flow chart of the security assessment method on the mobile phone end. The security assessment method comprises:
1. When the system version of the mobile phone is lower than the latest released version, the security attribute information in this dimension does not pass the security test.
2. When a Trojan or a serious loophole is found, the security attribute information in this dimension does not pass the security test.
3. When the mobile phone does not enable SELinux (Security-Enhanced Linux) or enter developer mode, the security attribute information in this dimension does not pass the security test. Here, Linux is an operating system.
4. When the mobile phone is connected to a passwordless network, the security attribute information in this dimension does not pass the security test.
5. When the version of the mobile application program is lower than the latest released version, the security attribute information in this dimension does not pass the security test.
6. When the user's password is simple or the password has not been changed for a long time, the security attribute information in this dimension does not pass the security test.
7. Based on the detection result of the security attribute information in each dimension, the assessment score is calculated to generate the assessment result, which is the third security index of the control end.

As stated above, the embodiment of the present disclosure proposes performing a security assessment on a local environment to obtain a third safety index when the security assessment instruction is received; sending the third security index to a server to trigger the server to obtain a first security index and a second security index, wherein the first security index is obtained by a door lock end performing a security assessment on a corresponding local environment, and the second security index is obtained by the server performing a security assessment on historical behavior data of the door lock end in a specified time period; and receiving a security assessment result sent by the server, wherein the security assessment result is calculated by the server based on the first security index, the second security index and the third security index. The present disclosure can evaluate the security of the door lock by combining three aspects of the door lock end, the control end and the historical behavior data, and the accuracy of the corresponding security assessment result of the door lock is improved.

In a following embodiment, it will be illustrated from the perspective of a third door lock security evaluation device. The third door lock security evaluation device can be integrated in the third electronic device, and the third electronic device can be a device corresponding to the door lock end.

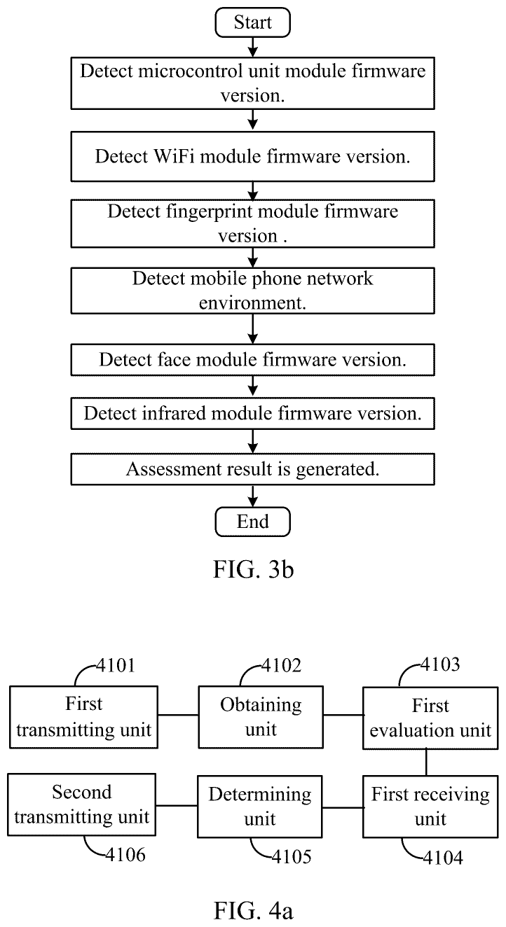

As shown in FIG. 3a, the flow of the door lock security evaluation method comprises:
301: receiving the security evaluation instruction sent by a server, wherein the security evaluation instruction is issued after the server receives the third security index, and the third security index is obtained by the control end performing a local security environment assessment.
302: performing a security assessment on a local environment according to the security assessment instruction to obtain a first safety index.
303: sending the first security index to the server to trigger the server to calculate a security assessment result of the door lock based on the first security index, a second security index and the third security index, wherein the second security index is obtained by the server performing a security assessment on historical behavior data of a door lock end within a specified period of time.

Optionally, the step of performing the security assessment on the local environment according to the security assessment instruction to obtain the first safety index may include: determining a risk factor corresponding to security attribute information in each dimension of the local environment according to the security assessment instruction; detecting whether a attribute value corresponding to the security attribute information in the dimension satisfies a preset security condition; and obtaining the first security index based on the detection result and the risk factor of the security attribute information in each dimension.

Here, the local environment could be the environment corresponding to the door lock end. The security attribute information of the door lock end in each dimension can include the firmware version information of the MCU (Microcontroller Unit) module, the firmware version information of the WiFi (wireless communication technology) module, and the firmware version information of the fingerprint module.

The detection result of the security attribute information in each dimension can be recorded as D. When the attribute value corresponding to the security attribute information on the dimension meets the preset security condition, the security attribute information on the dimension can be regarded as passing the security test, and the detection result D is set to 1. When the attribute value of the security attribute on the dimension does not meet the preset security condition, the security attribute on the dimension can be regarded as failing the security test, and the detection result D is set to 0.

The preset safety condition can be set according to the actual situation and is not a limitation of the present disclosure. For example, when the security attribute information in a dimension is the firmware version of the MCU module, and its attribute value can be the version number, the preset security condition can be that the firmware version of the MCU module is not lower than the latest released version. In another example, the security attribute information in a certain dimension is the firmware version of the fingerprint module, and its attribute value can be the version number, and the preset security condition can be that the firmware version of the fingerprint module is not lower than the latest released version.

The step of obtaining the first security index based on the detection result and the risk factor of the security attribute information in each dimension may comprise: taking the risk factor of the security attribute information in each dimension a weight; and based on the weight, performing a weighted operation on the detection result of the security attribute information in each dimension to obtain the first security index.

It is understandable that the first safety index can also be obtained by other means, which are not limited in this embodiment.

For example, the security assessment detection items (the security attribute information in each dimension) may include: MCU module firmware version information, WiFi module firmware version information, fingerprint module firmware version information, etc. The detection result of each security assessment test item is recorded as Di, the risk factor is recorded as Ri, and the third security index is recorded as P3. Then the corresponding first security index of the mobile phone can be:

$$P 1 = 100 - 100 \times {\sum }_{i = 1}^{n} DiRi .$$

The sum of the risk factors of each security assessment test item can be 1.

As shown in FIG. 3b, the flow chart of the security assessment method of the smart door lock end is shown. The security assessment method comprises:
1. Detect MCU module firmware version information. When the version is lower than the latest release version, the security attribute information in this dimension does not pass the security test.
2. Detect WiFi module firmware version information. When the version is lower than the latest released version, the security attribute information in this dimension does not pass the security test.
3. Detect fingerprint module firmware version information. When the version is lower than the latest release version, the security attribute information in this dimension does not pass the security test.
4. Detect human face module firmware version information. When the firmware version is lower than the latest released version, the security attribute information in this dimension does not pass the security test.
5. Detect the infrared module firmware version information. When the version is lower than the latest released version, the security attribute information in this dimension will not pass the security test.
6. Based on the detection result of the security attribute information in each dimension, the assessment score is calculated, and the assessment result is generated accordingly. The assessment result is the first security index of the door lock end.

The present disclosure can make the user have a clear understanding of the security of the smart door lock through the multi-dimensional security assessment of the mobile phone control end, the smart door lock end and the cloud platform end corresponding to the smart door lock. Based on the security assessment results, some unsafe settings and behaviors of the user can be prompted, so as to ensure the safety of the user and the property and improve the security of the smart door lock.

As stated above, the embodiment of the present disclosure proposes receiving the security evaluation instruction sent by a server, wherein the security evaluation instruction is issued after the server receives the third security index, and the third security index is obtained by the control end performing a local security environment assessment; performing a security assessment on a local environment according to the security assessment instruction to obtain a first safety index; sending the first security index to the server to trigger the server to calculate a security assessment result of the door lock based on the first security index, a second security index and the third security index, wherein the second security index is obtained by the server performing a security assessment on historical behavior data of a door lock end within a specified period of time. The present disclosure can evaluate the security of the door lock by combining three aspects, the door lock end, the control end and the historical behavior data, and the accuracy of the corresponding security assessment result of the door lock is improved.

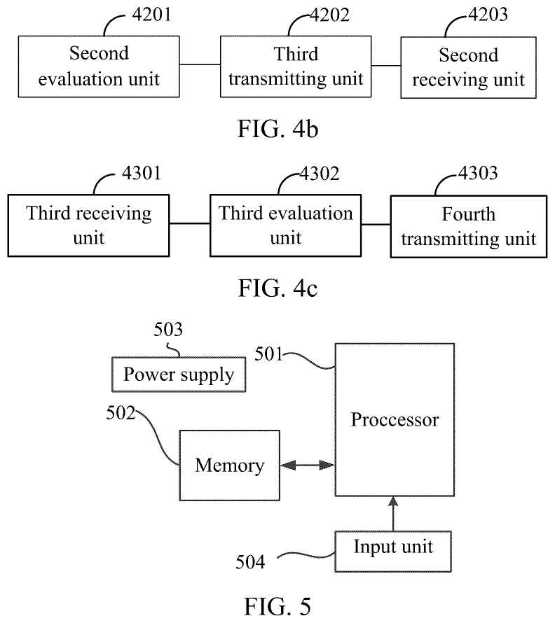

In order to better implement the above method, a door lock security evaluation system is disclosed. The door lock security evaluation system comprises a first door lock security evaluation device 41, a second door lock security evaluation device 42 and a third door lock security evaluation device 43. The first door lock security evaluation device 41 can be integrated in the server, the second door lock security evaluation device 42 can be regarded as the control terminal of the door lock, and the third door lock security evaluation device 43 can be regarded as the door lock end. As shown in FIG. 4a, the first door lock security evaluation device 41 may comprise a first transmitting unit 4101, an obtaining unit 4102, a first evaluation unit 4103, a first receiving unit 4104, a determining unit 4105, and a second transmitting unit 4106. As shown in FIG. 4b, the second door lock security evaluation device 42 may comprise a second evaluation unit 4201, a third transmitting unit 4202 and a second receiving unit 4203. As shown in FIG. 4c, the third door lock safety evaluation device 43 may comprise a third receiving unit 4301, a third evaluation unit 4302 and a fourth transmitting unit 4303.
A: The first door lock security evaluation device 41:
(1) The first transmitting unit 4101: The first transmitting unit is used for sending a safety evaluation instruction to the door lock end to trigger the door lock end to perform the local safety environment assessment and obtain a first safety index corresponding to the door lock end.
(2) The obtaining unit 4102: The obtaining unit is used for obtaining historical behavior data for the door lock end within a specified time period.
(3) The first evaluation unit 4103: The first evaluation unit is used for performing a security evaluation analysis on the historical behavior data to obtain a second safety index.

Optionally, the historical behavior data includes at least one historical interaction information;

The first evaluation unit may comprise an analysis subunit and a first determining subunit.

The analysis subunit is used for performing an abnormality analysis of at least one dimension on the historical behavior data based on an interaction time corresponding to each historical interaction information to obtain an abnormal result in at least one dimension.

The first determination subunit is used for determining the second safety index according to the formula:

$$P 2 = 100 - 100 \times {\sum }_{i = 1}^{n} DiRi ,$$

where P2 represents the second safety index, Ri represents a corresponding risk factor of each dimension, Di represents the abnormal result in each dimension, and n represents a number of dimensions.

Optionally, the analysis subunit may be used for detecting whether there is historical interaction information where the interaction time belongs to a preset abnormal time in the historical behavior data to obtain the first abnormal result; or analyzing an abnormal frequency of the historical behavior data based on the interaction time corresponding to each historical interaction information to obtain a second abnormal result.
(4) The first receiving unit 4104: The first receiving unit is used for receiving a third security index sent by a control end and the first security index sent by the door lock end, wherein the third security index is obtained by the control end performing the local security environment assessment.
(5) The determining unit 4105: The determining unit is used for determining the unit for determining the security assessment result of the door lock based on the first safety index, the second security index and the third safety index.

Optionally, the deterministic unit may comprise a calculation subunit and a second determining subunit.

The calculation subunit is used for calculating a corresponding security assessment score of the door lock based on the formula P=(P1+P2+P3)/3, wherein P represents the security assessment score, P1 represents the first security index, P2 represents the second security index, and P3 represents the first security index.

The second determining subunit is used for determining the security assessment result of the door lock according to the security assessment score.

Optionally, the second determinant subunit may be used for, when the security assessment score is greater than a preset value, generating a first security assessment result for the door lock; and when the security assessment score is not greater than the preset value, generating a second security assessment result for the door lock.
(6) The second transmitting unit 4106; The second transmitting unit is used for sending the security assessment result of the door lock to the control end.
B: The second door lock security evaluation device 42:
(7) The second evaluation unit 4201:

The second evaluation unit is used for performing a security assessment on a local environment to obtain a third safety index when the security assessment instruction is received.

Optionally, the second evaluation unit may comprise a third determining subunit, a first detection subunit and a fourth determining subunit.

The third determining subunit is used for, when the security assessment instruction is received, determining a risk factor corresponding to security attribute information in the dimension of the local environment.

The first detection subunit is used for detecting whether a attribute value corresponding to the security attribute information in the dimension satisfies a preset security condition.

The fourth determining subunit is used for obtaining the third security index based on a detection result and the risk factor of the security attribute information in each dimension.
(8) The third transmitting unit 4202: The third transmitting unit is used for sending the third security index to a server to trigger the server to obtain a first security index and a second security index, wherein the first security index is obtained by a door lock end performing a security assessment on a corresponding local environment, and the second security index is obtained by the server performing a security assessment on historical behavior data of the door lock end in a specified time period
(9) The second receiving unit 4203: The second receiving unit is used for receiving a security assessment result sent by the server, wherein the security assessment result is calculated by the server based on the first security index, the second security index and the third security index.
C: The third door lock security evaluation device 43:
(10) The third receiving unit 4301: The third receiving unit is used for receiving the security evaluation instruction sent by a server, wherein the security evaluation instruction is issued after the server receives the third security index, and the third security index is obtained by the control end performing a local security environment assessment.
(11) Third evaluation unit 4302: The third evaluation unit is used for performing a security assessment on a local environment according to the security assessment instruction to obtain a first safety index.

Optionally, the third evaluation unit may include a fifth determining subunit, a second detection subunit and a sixth determining subunit.

The fifth determination subunit is used for determining a risk factor corresponding to security attribute information in each dimension of the local environment according to the security assessment instruction.

The second detection subunit is used for detecting whether a attribute value corresponding to the security attribute information in the dimension satisfies a preset security condition.

The sixth determining subunit is used for obtaining the first security index based on the detection result and the risk factor of the security attribute information in each dimension.
(12) The fourth transmitting unit 4303: The fourth transmitting unit is used for sending the first security index to the server to trigger the server to calculate a security assessment result of the door lock based on the first security index, a second security index and the third security index, wherein the second security index is obtained by the server performing a security assessment on historical behavior data of a door lock end within a specified period of time.

As stated above, the embodiment of the present disclosure proposes a door lock security assessment. The first transmitting unit 4101 is configured for sending a security evaluation instruction to a door lock end to trigger the door lock end to perform a local security environment assessment and obtain a first safety index corresponding to the door lock end. The obtaining unit 4102 is configured for obtaining historical behavior data for the door lock end within a specified time period. The first evaluation unit 4103 is configured for performing a security evaluation analysis on the historical behavior data to obtain a second safety index. The first receiving unit 4104 is configured for receiving a third security index sent by a control end and the first security index sent by the door lock end, wherein the third security index is obtained by the control end performing the local security environment assessment. The determining unit 4105 is configured for determining a security assessment result of a door lock based on the first security index, the second security index and the third security index. The second transmitting unit 4106 is configured for sending the security assessment result of the door lock to the control end.

As stated above, the embodiment of the present disclosure proposes a door lock security assessment. The second evaluation unit 4201 is configured for performing a security assessment on a local environment to obtain a third safety index when the security assessment instruction is received. The third transmitting unit 4202 is configured for sending the third security index to a server to trigger the server to obtain a first security index and a second security index, wherein the first security index is obtained by a door lock end performing a security assessment on a corresponding local environment, and the second security index is obtained by the server performing a security assessment on historical behavior data of the door lock end in a specified time period. The second receiving unit 4203 is configured for receiving a security assessment result sent by the server, wherein the security assessment result is calculated by the server based on the first security index, the second security index and the third security index. The present disclosure can evaluate the security of the door lock by combining three aspects, the door lock end, the control end of the door lock and the historical behavior data, and the accuracy of the corresponding security assessment results of the door lock is improved.

As stated above, the embodiment of the present disclosure proposes a door lock security assessment. The third receiving unit 4301 is configured for receiving the security evaluation instruction sent by a server, wherein the security evaluation instruction is issued after the server receives the third security index, and the third security index is obtained by the control end performing a local security environment assessment. The third evaluation unit 4302 is configured for performing a security assessment on a local environment according to the security assessment instruction to obtain a first safety index. The fourth transmitting unit 4303 is configured for sending the first security index to the server to trigger the server to calculate a security assessment result of the door lock based on the first security index, a second security index and the third security index, wherein the second security index is obtained by the server performing a security assessment on historical behavior data of a door lock end within a specified period of time.

The present disclosure can evaluate the security of the door lock by combining three aspects: the door lock end, the control end of the door lock and the historical behavior data, and the accuracy of the corresponding security assessment results of the door lock is improved.

Refer to FIG. 5 illustrating a schematic diagram of the electronic device according to another embodiment of the present disclosure. The embodiment of the present disclosure also provides an electronic device which may be a terminal or a server.

The electronic device may comprise components such as a processor 501 for one or more processing cores, a memory 502 for one or more computer-readable storage media, a power supply 503 and an input unit 504. Those skilled in the art can understand that the structure of the electronic device shown in FIG. 5 does not constitute a limitation of the electronic device, and may include more or fewer parts than illustrated, or combine certain parts, or arrange different parts.

The processor 501 is the control center of the electronic device, which uses various interfaces and lines to connect the various parts of the entire electronic device by running or executing software programs stored in memory 502 and/or modules, as well as calling up the data stored in memory 502, performing various functions and processing data of the electronic device, so as to carry out overall monitoring of the electronic device. Optionally, the processor 501 may include one or more processing cores. Preferably, the processor 501 can integrate an application processor and a modem processor, wherein the application processor mainly processes the operating system, user interface and application and the like, and the modem processor mainly processes wireless communication. It is understandable that the aforementioned modem processor can also be left unintegrated into the processor 501.

The memory 502 can be used to store software programs and modules, and the processor 501 performs various functional applications and data processing by running software programs and modules stored in memory 502. The memory 502 may mainly include a storage program area and a storage data area, wherein the storage program area can store the operating system, at least one function required application (such as sound playback function, image playback function, etc.). The storage data area can store data created based on the use of electronic devices, etc. In addition, the memory 502 may include high-speed random access memory and may include non-volatile memory, such as at least one disk storage device, flash memory device, or other volatile solid-state memory device. Correspondingly, memory 502 may also include a memory controller to provide access from processor 501 to memory 502.

The electronic device also comprises a power supply 503 for supplying power to each component. Preferably, the power supply 503 can be connected with the processor 501 through the power management system, so that the functions such as managing charging, discharging, and power consumption management can be realized through the power management system. The Power Supply 503 can also include any component such as one or more DC or AC power sources, recharging systems, power fault detection circuits, power converters or inverters, and power status indicators.

The electronic device may also include an input unit 504 that can be used to receive input numeric or character information and to generate keyboard, mouse, joystick, optical or trackball signal input related to user settings and function control.

Although not shown, the electronic device may also include display units, etc., which will not be repeated here. Specifically, in this embodiment, the processor 501 in the electronic device will load the executable file corresponding to the process of one or more applications into the memory 502 according to the following instructions, and the processor 501 will run the application stored in the memory 502, thereby realizing various operations. The operations comprise: sending a security evaluation instruction to a door lock end to trigger the door lock end to perform a local security environment assessment and obtaining a first safety index corresponding to the door lock end; obtaining historical behavior data for the door lock end within a specified time period; performing a security evaluation analysis on the historical behavior data to obtain a second safety index; receiving a third security index sent by a control end and the first security index sent by the door lock end, wherein the third security index is obtained by the control end performing the local security environment assessment; determining a security assessment result of a door lock based on the first security index, the second security index and the third security index; sending the security assessment result of the door lock to the control end.

Or, the operations comprise: performing a security assessment on a local environment to obtain a third safety index when the security assessment instruction is received; sending the third security index to a server to trigger the server to obtain a first security index and a second security index, wherein the first security index is obtained by a door lock end performing a security assessment on a corresponding local environment, and the second security index is obtained by the server performing a security assessment on historical behavior data of the door lock end in a specified time period; and receiving a security assessment result sent by the server, wherein the security assessment result is calculated by the server based on the first security index, the second security index and the third security index.

Or, the operations comprise: receiving the security evaluation instruction sent by a server, wherein the security evaluation instruction is issued after the server receives the third security index, and the third security index is obtained by the control end performing a local security environment assessment; performing a security assessment on a local environment according to the security assessment instruction to obtain a first safety index; and sending the first security index to the server to trigger the server to calculate a security assessment result of the door lock based on the first security index, a second security index and the third security index, wherein the second security index is obtained by the server performing a security assessment on historical behavior data of a door lock end within a specified period of time.

The specific implementation of each of the above operations can be found in the previous embodiment, which will not be repeated here.

It can be seen from the above that the present embodiment, by sending a security evaluation instruction to a door lock end to trigger the door lock end to perform a local security environment assessment and obtaining a first safety index corresponding to the door lock end; obtaining historical behavior data for the door lock end within a specified time period; performing a security evaluation analysis on the historical behavior data to obtain a second safety index; receiving a third security index sent by a control end and the first security index sent by the door lock end, wherein the third security index is obtained by the control end performing the local security environment assessment; determining a security assessment result of a door lock based on the first security index, the second security index and the third security index; sending the security assessment result of the door lock to the control end, the present disclosure can evaluate the security of the door lock by combining three aspects: the door lock end, the control end and the historical behavior data, and the accuracy of the corresponding security assessment results of the door lock is improved.

A person skilled in the art may understand that all or part of the steps in the various methods of the above embodiments may be completed by computer-readable instructions, or by controlling related hardware through computer-readable instructions, and the computer-readable instructions may be stored in a computer-readable storage medium and loaded and executed by a processor.

In addition, the embodiment of the present disclosure provides a non-transitory computer-readable storage medium storing a plurality of computer-readable instructions. The computer-readable instructions can be loaded by a processor to perform the steps in any of the door lock security assessment methods provided in the embodiment of the present disclosure. For example, the computer-readable instructions executed by the processor to perform operations to realize various functions.

The operations comprise: sending a security evaluation instruction to a door lock end to trigger the door lock end to perform a local security environment assessment and obtaining a first safety index corresponding to the door lock end; obtaining historical behavior data for the door lock end within a specified time period; performing a security evaluation analysis on the historical behavior data to obtain a second safety index; receiving a third security index sent by a control end and the first security index sent by the door lock end, wherein the third security index is obtained by the control end performing the local security environment assessment; determining a security assessment result of a door lock based on the first security index, the second security index and the third security index; sending the security assessment result of the door lock to the control end.

Or, the operations comprise: performing a security assessment on a local environment to obtain a third safety index when the security assessment instruction is received; sending the third security index to a server to trigger the server to obtain a first security index and a second security index, wherein the first security index is obtained by a door lock end performing a security assessment on a corresponding local environment, and the second security index is obtained by the server performing a security assessment on historical behavior data of the door lock end in a specified time period; and receiving a security assessment result sent by the server, wherein the security assessment result is calculated by the server based on the first security index, the second security index and the third security index.

Or, the operations comprise: receiving the security evaluation instruction sent by a server, wherein the security evaluation instruction is issued after the server receives the third security index, and the third security index is obtained by the control end performing a local security environment assessment; performing a security assessment on a local environment according to the security assessment instruction to obtain a first safety index; and sending the first security index to the server to trigger the server to calculate a security assessment result of the door lock based on the first security index, a second security index and the third security index, wherein the second security index is obtained by the server performing a security assessment on historical behavior data of a door lock end within a specified period of time.

The specific implementation of each of the above operations can be found in the previous embodiment, which will not be repeated here.

Among them, the non-volatile computer-readable storage medium may include: Read Only Memory (ROM), Random Access Memory (RAM), disk or optical disc, etc.

Because the instructions stored in the non-volatile computer-readable storage medium can perform the steps in any of the door lock security assessment methods provided in the embodiment of the present disclosure, the beneficial effects that can be achieved by any of the door lock security assessment methods provided in the embodiment of the present disclosure can be realized, see the previous embodiment for details, and will not be repeated herein.

According to one aspect of the present disclosure, a computer program product or computer program consisting of computer-readable instructions stored in a non-volatile computer-readable storage medium is provided. The processor of a computer device reads the computer-readable instructions from a non-volatile computer-readable storage medium, and the processor executes the computer-readable instructions, causing the computer device to perform the methods provided in the various optional implementations for the security evaluation of the door lock.

The above is a door lock security assessment method and related equipment provided by the embodiment of the present disclosure in detail, the principle and embodiment of the present disclosure are described in this paper by applying specific examples, and the description of the above embodiment is only used to help understand the method of the present disclosure and its core idea. At the same time, for those skilled in the art, there will be changes in the specific embodiment and scope of the present disclosure according to the idea of the present disclosure. In summary, the contents of this specification should not be construed as a restriction on the present disclosure.

1. A door lock security assessment method, the method comprising:
sending a security evaluation instruction to a door lock end to trigger the door lock end to perform a local security environment assessment and obtain a first safety index corresponding to the door lock end;
obtaining historical behavior data for the door lock end within a specified time period;
performing a security evaluation analysis on the historical behavior data to obtain a second safety index;
receiving a third security index sent by a control end and the first security index sent by the door lock end, wherein the third security index is obtained by the control end performing the local security environment assessment;
determining a security assessment result of a door lock based on the first security index, the second security index and the third security index; and
sending the security assessment result of the door lock to the control end.

2. The method of claim 1, wherein the historical behavior data comprises at least one historical interaction information; and the step of performing the security evaluation analysis on the historical behavior data to obtain the second safety index comprises:
performing an abnormality analysis of at least one dimension on the historical behavior data based on an interaction time corresponding to each historical interaction information to obtain an abnormal result in at least one dimension; and
determining the second safety index according to the formula:
P2=100−100×Σᵢ₌₁ⁿDiRi,
where P2 represents the second safety index, Ri represents a corresponding risk factor of each dimension, Di represents the abnormal result in each dimension, and n represents a number of dimensions.

3. The method of claim 2, wherein the step of performing the abnormality analysis of at least one dimension on the historical behavior data based on the interaction time corresponding to each historical interaction information to obtain the abnormal result in at least one dimension comprises:
detecting whether there is historical interaction information where the interaction time belongs to a preset abnormal time in the historical behavior data to obtain the first abnormal result; or
analyzing an abnormal frequency of the historical behavior data based on the interaction time corresponding to each historical interaction information to obtain a second abnormal result.

4. The method of claim 1, wherein the step of determining the security assessment result of the door lock based on the first security index, the second security index and the third security index comprises:
calculating a corresponding security assessment score of the door lock based on the formula P=(P1+P2+P3)/3, wherein P represents the security assessment score, P1 represents the first security index, P2 represents the second security index, and P3 represents the first security index; and
determining the security assessment result of the door lock according to the security assessment score.

5. The method of claim 4, wherein the step of determining the security assessment result of the door lock according to the security assessment score comprises:
when the security assessment score is greater than a preset value, generating a first security assessment result for the door lock; and
when the security assessment score is not greater than the preset value, generating a second security assessment result for the door lock.

6. A door lock security assessment method, the method comprising:
performing a security assessment on a local environment to obtain a third safety index when the security assessment instruction is received;
sending the third security index to a server to trigger the server to obtain a first security index and a second security index, wherein the first security index is obtained by a door lock end performing a security assessment on a corresponding local environment, and the second security index is obtained by the server performing a security assessment on historical behavior data of the door lock end in a specified time period; and
receiving a security assessment result sent by the server, wherein the security assessment result is calculated by the server based on the first security index, the second security index and the third security index.

7. The method of claim 6, when the step of performing the security assessment on the local environment to obtain the third safety index when the security assessment instruction is received comprises:
when the security assessment instruction is received, determining a risk factor corresponding to security attribute information in the dimension of the local environment;
detecting whether a attribute value corresponding to the security attribute information in the dimension satisfies a preset security condition; and
obtaining the third security index based on a detection result and the risk factor of the security attribute information in each dimension.

8. The method of claim 7, wherein the step of obtaining the third security index based on detection results and risk factors of the security attribute information in each dimension comprises:
taking the risk factor of the security attribute information in each dimension a weight; and
based on the weight, performing a weighted operation on the detection result of the security attribute information in each dimension to obtain the third security index corresponding to the control end.

9. A door lock security assessment method, the method comprising:
receiving the security evaluation instruction sent by a server, wherein the security evaluation instruction is issued after the server receives the third security index, and the third security index is obtained by the control end performing a local security environment assessment;
performing a security assessment on a local environment according to the security assessment instruction to obtain a first safety index; and
sending the first security index to the server to trigger the server to calculate a security assessment result of the door lock based on the first security index, a second security index and the third security index, wherein the second security index is obtained by the server performing a security assessment on historical behavior data of a door lock end within a specified period of time.

10. The method of claim 9, wherein the step of performing the security assessment on the local environment according to the security assessment instruction to obtain the first safety index comprises:
determining a risk factor corresponding to security attribute information in each dimension of the local environment according to the security assessment instruction;
detecting whether an attribute value corresponding to the security attribute information in the dimension satisfies a preset security condition; and
obtaining the first security index based on the detection result and the risk factor of the security attribute information in each dimension.

11. The method of claim 9, wherein the step of obtaining the first security index based on the detection result and the risk factor of the security attribute information in each dimension comprises:
taking the risk factor of the security attribute information in each dimension a weight; and
based on the weight, performing a weighted operation on the detection result of the security attribute information in each dimension to obtain the first security index.

12-17. (canceled)
